(19) United States
(12) Patent Application Publication
(10) Pub. No.: US 2015/0134625 A1
(43) Pub. Date: May 14, 2015

(54) PRUNING OF SERVER DUPLICATION INFORMATION FOR EFFICIENT CACHING

(71) Applicant: NetApp, Inc., Sunnyvale, CA (US)

(72) Inventors: James F. Lentini, Waltham, MA (US); Anshul Madan, Waltham, MA (US); Deepak R. Kenchammana-Hosekote, Sunnyvale, CA (US)

(21) Appl. No.: 14/079,549

(22) Filed: Nov. 13, 2013

(51) Int. Cl. G06F 17/30; H04L 29/08

(52) U.S. Cl. CPC G06F 17/30303; H04L 67/2857
USPC 707/692

(57) ABSTRACT

Technology is disclosed for improving the storage efficiency and communication efficiency for a storage client device by maximizing the cache hit rate and minimizing data requests to the storage server. The storage server provides a duplication list to the storage client device. The duplication list contains references (e.g. storage addresses) to data blocks that contain duplicate data content. The storage client uses the duplication list to improve the cache hit rate. The duplication list is pruned to contain references to data blocks relevant to the storage client device. The storage server can prune the duplication list based on a working set of storage objects for a client. Alternatively, the storage server can prune the duplication list based on content characteristics, e.g. duplication degree and access frequency. Duplicate blocks to which the client does not have access can be excluded from the duplication list.

### BACKGROUND

Modern data centers extensively use server virtualization techniques. Server virtualization techniques enable better utilization of hardware resources and therefore reduce data center cost. By separating the physical computing system from the operating system and application software, virtualization enables dynamic allocation of resources, e.g., hardware or virtual machines. Data center administrators have the flexibility to move workloads from one server to another for balancing load, maintaining hardware, and enabling high availability.

Modern data centers also extensively use shared storage technology, including, e.g., network attached storage (NAS) and storage area networks (SAN). Both NAS and SAN technologies enable unified and centralized data management, which makes it easier for data center administrators to manage data. The administrators can choose the level of data protection (e.g. using redundant array of independent disks, “RAID”), enable mirroring for disaster recovery, and carefully configure the backup policies. Shared storage systems enable additional storage space to be dynamically added and reassigned. Centralization of the shared storage provides opportunities for deduplication to achieve greater storage efficiency.

Recently, flash-based solid-state drives (“SSDs”) are employed in environments associated with the virtualized, shared storage data centers. Flash is treated as an additional tier in the memory hierarchy between DRAM and magnetic hard disks. In terms of cost per gigabyte (“GB”), dynamic random-access memory (“DRAM”) capacity is more expensive than flash capacity, which in turn is more expensive than hard disk capacity. At the same time, DRAM latencies are less than flash, and flash latencies are less than magnetic hard disk. As a result, flash's cost per input/output (“I/O”) operation is between DRAM and magnetic hard disks. Recently, large caches have become increasingly common with the emergence of flash devices. As a result, companies have released flash caching products including, e.g., NetApp Flash Accel, EMC VFCache, and Fusion-io ioTurbine.

### BRIEF DESCRIPTION OF THE DRAWINGS

Objects, features and characteristics of the disclosed technology will become more apparent to those skilled in the art from a study of the following detailed description in conjunction with the appended claims and drawings, all of which form a part of this specification. In the drawings:

FIG. 1 is a block diagram illustrating a network storage environment, in which the technology can operate in various embodiments.

FIG. 2 is a block diagram illustrating a clustered network storage environment, in which the technology can operate in various embodiments.

FIG. 3 is a high-level block diagram illustrating an example of hardware architecture of a storage controller that can implement one or more storage host devices or storage client devices, in various embodiments.

FIG. 4 is a block diagram illustrating an example of a storage operating system of a storage host device, in which the technology can be implemented in various embodiments.

FIG. 5 is a flow diagram illustrating a process for a cache processing of an I/O command, in various embodiments.

FIG. 6 is block diagram illustrating an example of a cache data structure for a cache consisting of a cache header array, an address map and a fingerprint map, in various embodiments.

FIG. 7 is a flow diagram illustrating a process for pruning a server duplication list based on a client's working set.

FIG. 8 is a flow diagram illustrating a process for using a server duplication list to improve a cache hit rate in a storage client.

FIG. 9 is a flow diagram illustrating a process for pruning a server duplication list based on data content's characteristics.

FIG. 10 is a flow diagram illustrating a process for pruning a server duplication list based on access control lists.

### DETAILED DESCRIPTION

References in this specification to “an embodiment,” “one embodiment,” or the like, mean that the particular feature, structure, or characteristic being described is included in at least one embodiment of the disclosed technology. Occurrences of such phrases in this specification do not all necessarily refer to the same embodiment or all embodiments, however.

The technology disclosed herein employs duplication lists to improve the storage efficiency and communication efficiency for a storage client device by maximizing the cache hit rate and minimizing data requests to the storage server. Storage clients access data stored at storage services. The storage server provides a duplication list to the storage client device. The duplication list contains references (e.g. storage addresses) to data blocks that contain duplicate data content. The storage client uses the duplication list to improve the cache hit rate.

For example, the storage client can insert the information of the duplication list into an address map associated with its cache. When the storage client tries to read a data block, the storage client first consult the address map to determine whether there is a cached data block for the data block associated with the reference. If such a data block exists in the cache, the storage client device is able to retrieve the data to satisfy the read request directly from the cache, without sending any data request to the storage server over a network.

The duplication list can be pruned to contain references to data blocks relevant to the storage client device. The storage server can prune the duplication list based on a working set of storage objects for a client. Alternatively, the storage server can prune the duplication list based on content characteristics, e.g. duplication degree and access frequency. A duplication degree of a data chunk is, or can be calculated from, a number of duplicate data chunks that have the same content. Duplicate blocks to which the client does not have access can also be excluded from the duplication list.

The technology disclosed herein allows a flash-based SSD cache (or other type of hardware media such as storage class memory) in a storage client device to exploit the duplication information maintained by a storage server. The storage client cache can employ this duplication information to efficiently utilize the cache space and reduce or eliminate unnecessary communications with the storage server. For example, suppose there is a cache storing a single copy of data for disparate chunks of data whose contents are exactly duplicated in separate storage server locations. Such a cache may be able to store twice the data in the same amount of storage as would be possible without taking advantage of the storage server maintained duplication information.

### System Environment

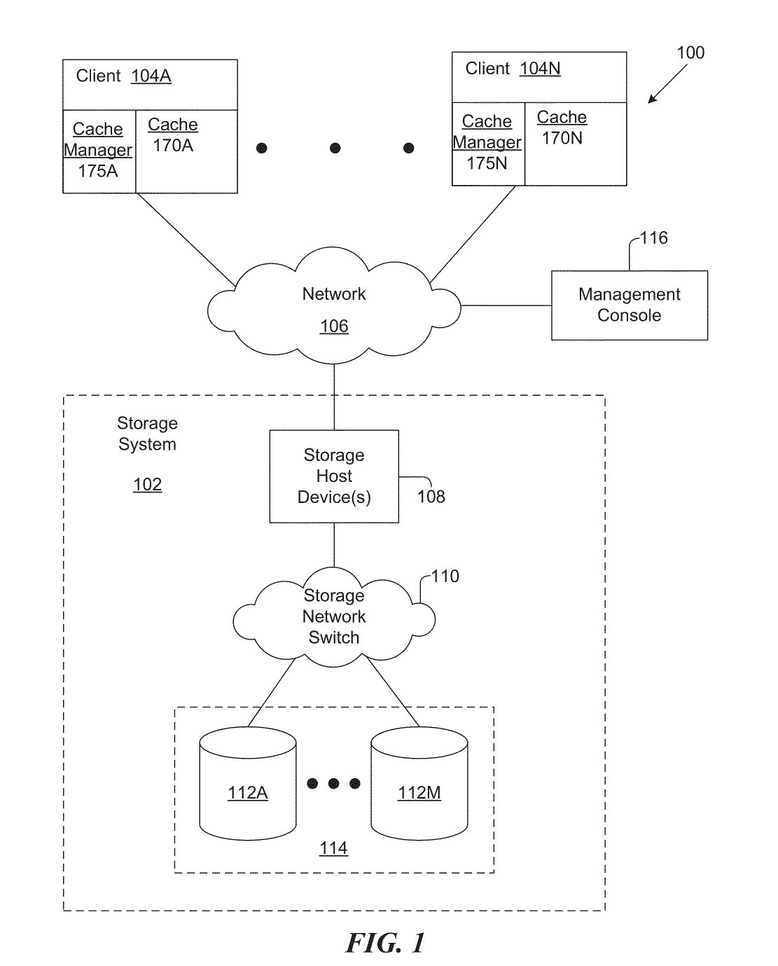

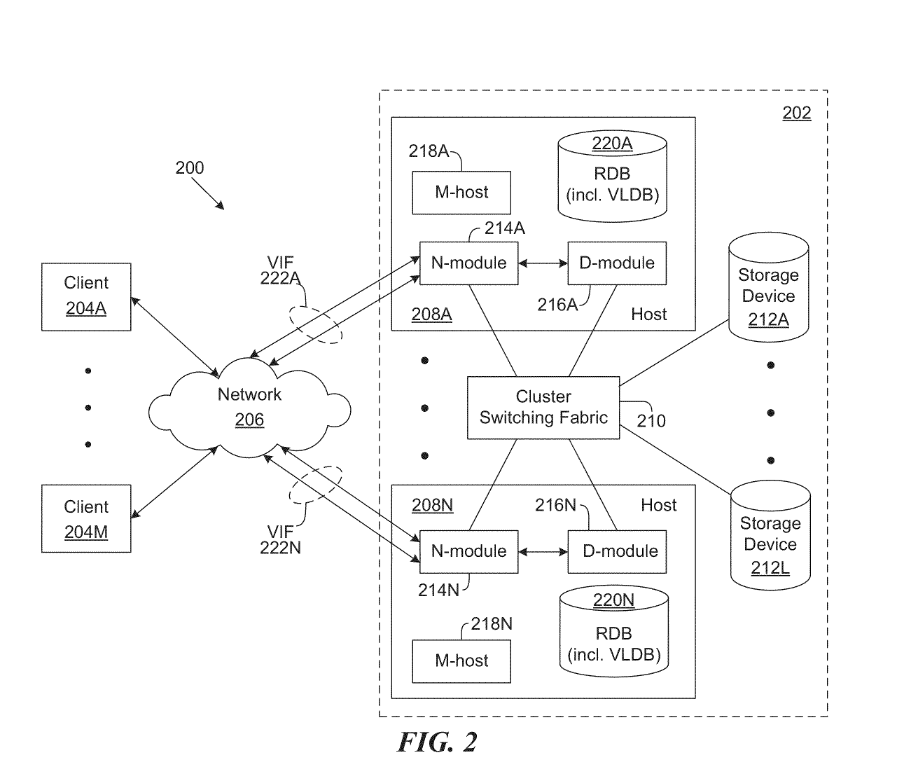

Turning now to the Figures, FIGS. 1 and 2 illustrate, at different levels of detail, storage environment configurations in which the technology can be implemented. Client computing devices (“clients”) are presented with a clustered storage system having multiple mass storage devices that can be managed by multiple storage host devices.

Referring to FIG. 1, FIG. 1 is a block diagram illustrating a network storage environment 100, in which the technology can operate in various embodiments. The storage environment 100 includes multiple client computing devices or systems 104A-104N, a storage system 102, and a network 106 connecting the client systems 104A-104N and the storage system 102. As illustrated in FIG. 1, the storage system 102 includes at least one storage host device 108, a storage network switch 110, and one or more mass storage devices 112A-112M, e.g., conventional magnetic disks, optical disks (e.g. CD-ROM or DVD based storage), magneto-optical (MO) storage, flash memory storage device or any other type of non-volatile storage devices suitable for storing structured or unstructured data. The examples disclosed herein may reference a storage device as a “disk” but the embodiments disclosed herein are not limited to disks or any particular type of storage media/device. The mass storage devices 112A-112M may be associated with a mass storage subsystem 114.

The storage host devices (or servers) 108 may be, for example, one of the storage server products available from NetApp, Inc., the assignee of the present application, or available from other vendors. The client systems 104A-104N may access the storage host device 108 via network 106, which can be a packet-switched network, for example, a local area network (LAN), a wide area network (WAN), the Internet, or any other type of network. The client systems 104A-104N can include caches 170A-170N to store data has been written or read so that future write or read requests for that data can be served directly from the caches 170A-170N. The caches 170A-170N can be, e.g., flash-based SSDs.

The client systems 104A-104N can further include cache managers 175A-175N to manage the data stored in the cache 170A-170N. The cache managers 175A-175N can be implemented as applications or services running on the client systems 104A-104N, firmware in the cache 170A-170N, or a combination thereof. The cache managers 175A-715N can maintain a server duplication address list for duplicate data stored in the network system 102. For example, if the client system 104A needs data associated with server address Lx, the client system 104A first requests the cache manager 175A to determine whether the cache 170A stores the data associated with Lx. If the cache 170A does not store the data associated with Lx, the cache manager 175A further checks the server duplication address list to determine if there is any server address associated with data that duplicates the data associated with Lx. The server duplication address list may be generated and sent by the storage system 102, for example. If there is such duplicate server address, the cache manager 175A determines whether the cache 170A stores the data associated with the duplicate server address. If so, the cache manager 175A returns the data to the client system 104A directly from the cache 170A to satisfy the local data request for Lx. If the cache 170A does not store the data associated with any duplicate server address, the cache manager 175A or the client system 104A sends a data request for the data associated with Lx to the storage system 102.

The caches 170A-170N improve I/O performance of the storage clients 104A-104N. The technology described herein can function with different types of caches, including those stored in volatile memory, non-volatile memory (e.g., storage class memory, or battery-backed DRAM), flash, disk, or some combination of these technologies.

The storage host device 108 may be connected to the storage devices 112A-112M via a storage network switch 110, which can be a Serial Attached SCSI (SAS) storage network switch or a fiber distributed data interface (FDDI), for example. It is noted that, within the network data storage environment, any other suitable numbers of storage servers and/or mass storage devices, and/or any other suitable network technologies, may be employed. Although FIG. 1 illustrates a fully connected storage network switch 110 in which storage host devices can access all mass storage devices, it is understood that such a connected topology is not required. In various embodiments, the storage devices can be directly connected to the storage servers such that two storage servers cannot both access a particular storage device concurrently.

The storage host device 108 can make some or all of the storage space on the mass storage devices 112A-112M available to the client systems 104A-104N e.g., in a conventional manner. For example, a mass storage device (one of 112A-112M) can be implemented as an individual disk, multiple disks (e.g., a RAID group) or any other suitable mass storage device(s). The storage host device 108 can communicate with the client systems 104A-104N according to well-known protocols, e.g., the Network File System (NFS) protocol or the Common Internet File System (CIFS) protocol, to make data stored at storage devices 112A-112M available to users and/or application programs.

The storage host device 108 can present or export data stored at mass storage device 112A-112M as volumes (also referred to herein as storage volumes) to one or more of the client systems 104A-104N. On or more volumes can be managed as a single Serial Attached SCSI (SAS) domain, for example. In various embodiments, a “file system” does not have to include or be based on “files” per se as its units of data storage. For example, the units of storage can be objects.

Various functions and configuration settings of the storage host device 108 and the mass storage subsystem 114 can be controlled from a management console 116 coupled to the network 106.

FIG. 2 is a block diagram illustrating a clustered network storage environment, in which the technology can operate in various embodiments. As illustrated in FIG. 2, a cluster based storage environment 200 includes multiple storage host devices. The storage environment 200 includes multiple client systems 204 (204A-204M), a clustered storage system 202, and a network 206 connecting the client systems 204. As illustrated in FIG. 2, the clustered storage system 202 includes multiple storage host devices (may also be referred to as “nodes,” “servers,” or “hosts”) 208A-208N, a cluster switching fabric 210, and multiple storage devices 212 (212A-212L). The storage devices 212A-212L can contain a large number of mass storage devices, that may each be removable.

The hosts 208A-208N can be configured to include several modules, including an N-module 214, a D-module 216, and an M-host 218 (each of which can be implemented by using a separate processor executable module) and an instance of a replicated database (RDB) 220. In the illustrated embodiment, host 208A includes an N-module 214A, a D-module 216A, and an M-host 218A; host 208N includes an N-module 214N, a D-module 216N, and an M-host 218N; and so forth. The N-modules 214A-214N include functionality that enables hosts 208A-208N, respectively, to connect to one or more of the client systems 204 over the network 206, while the D-modules 216A-216N provide access to the data stored at storage devices in storage devices 212A-212L. The M-hosts 218 provide management functions for the clustered storage system 202 including, e.g., snapshotting, deduplication, and encryption. Accordingly, the hosts 208A-208N in the clustered storage system can provide the functionality of a storage server.

In various embodiments, RDBs 220A-220N are instances of a database that are replicated throughout the cluster. For example, hosts 208A-208N can include instances of the RDBs 220A-220N. The RDBs 220A-220N can provide cluster-wide storage information used by hosts 208A-208N, including a volume location database (VLDB) (not illustrated). The VLDB is a database that indicates the location within the cluster of volumes in the cluster and is used by the hosts 208A-208N to identify the appropriate mass storage devices in storage devices 212A-212L for any given volume to which access is requested. The various instances of the RDBs 220A-220N can be updated regularly to bring them into synchronization with each other.

A switched virtualization layer including multiple virtual interfaces (VIFs) 222A-222N can be provided between the respective N-modules 214A-214N and the client systems 204A-204M, enabling the storage devices in storage devices 212A-212L associated with the hosts 208A-208N to be presented to the client systems as a single shared storage pool.

The clustered storage system 202 can be organized into any suitable number of virtual servers (also referred to as “vservers”), in which one or more vservers represent a single storage system namespace with separate network access. In various embodiments, each vserver has a user domain and a security domain that are separate from the user and security domains of other vservers. In some other embodiments, two or more vservers can have a common user domain and a common security domain. Moreover, a vserver can be associated with one or more VIFs 222A-222N and can span one or more physical hosts, each of which can hold one or more VIFs 222A-222N and storage associated with one or more vservers. Client systems can access the data on a vserver from any host of the clustered system, but generally access vservers via the VIFs 222A-222N associated with that vserver. It is noteworthy that the embodiments described herein are not limited to the use of vservers.

The hosts 208A-208N and the storage devices can be interconnected by a cluster switching fabric 210, which can be embodied as one or more storage network switches, for example. The N-modules 214A-214N and D-modules 216A-216N cooperate to provide highly-scalable storage system architecture implementing various embodiments of the technology. Although an equal number of N-modules and D-modules are illustrated in FIG. 2, there may be different numbers of N-modules and/or D-modules in accordance with various embodiments of the technology described here. For example, there need not be a one-to-one correspondence between the N-modules and D-modules. As such, the description of a node 208A-208N comprising one N-module and one D-module should be understood to be illustrative only.

In a shared storage environment as illustrated in FIGS. 1 and 2, a storage client, e.g., client 104A, can use a NAS (e.g., Network File System “NFS”, Common Internet File System “CIFS”) or SAN (e.g., Fibre Channel over Ethernet “FCoE”) protocol to access data on a storage server, e.g., storage system 102. Regardless of the protocol, the storage server may be aware of storage addresses associated with storage spaces (e.g., on storage 212A-212L) on servers that store duplicated content. In these instances, communicating the duplication information (e.g., as duplication lists) to the storage clients may improve the client's performance. For example, if locations Lₓ and L_{y} on a storage server 102 both store content C₁, the storage server 102 can communicate this duplication information to a storage client 104A. Once the storage client 104A retrieves content C₁ from the storage server 102 (e.g., by requesting data associated with either Lₓ or L_{y}), the storage client 104A can efficiently cache content C₁ for both addresses Lₓ and L_{y}. Thus, the storage client 104A can satisfy read requests locally for both Lₓ and L_{y}, rather than sending a read request to the storage server 102, which eliminates a read operation from being sent via the network 106.

To improve efficiency, a storage server may communicate only relevant duplication information that is relevant to the storage clients. Storage servers typically manage many times more data than storage clients. A storage server may be aware of many data duplicates that are of no interest to a storage client (e.g., because that storage client does not issue read requests for some of the duplicated content). As an example, consider a zero block (a block containing all zero bits). In modestly sized data sets with several gigabytes of data, the zero block can be duplicated hundreds of thousands of times. Storage servers can manage petabytes of data. It is inefficient for a storage client to receive a large amount of information about the data duplications that are irrelevant to the storage client.

The technology can also be employed with server virtualization, which stores operating systems of the virtual servers in storage servers. Multiple storage servers can contain the same or similar versions of operating systems or portions (e.g., files or blocks) thereof. Storing the same or similar versions of an operating system of the virtual servers results in a large number of duplicated data because a large amount of the operating system data (e.g., files) is common to them all. A storage client may request data via multiple virtual servers from the storage server, and therefore attempt to retrieve duplicate data.

Storage servers can select and communicate lists of duplicate blocks (or other units of duplicate data, e.g., logical unit number) to storage clients. For example, a storage server can include or “piggyback” a duplication list with the response to a read request. When a storage client 104A reads location Lₓ, the response from the storage server 102 can contain the contents of Lₓ and a list of locations where those contents are duplicated (e.g. L_{y}). As another example, a storage client can query the storage server for the duplication. The storage server can determine which data is relevant to the storage client and communicate a duplication list for the relevant data to the storage client.

### Hardware Architecture and Operating System

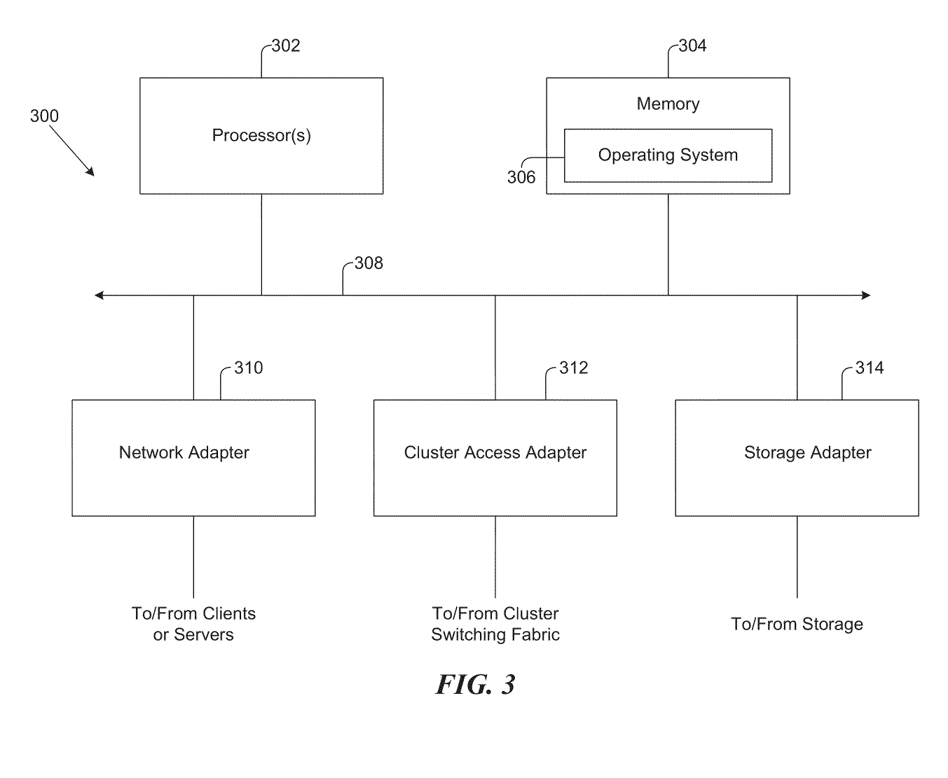

FIG. 3 is a high-level block diagram illustrating an example of a hardware architecture of a computing device 300 that can implement one or more storage host devices 208A-208N or storage client devices, in various embodiments. The computing device 300 executes some or all of the processor-executable instructions that are described below in detail. In various embodiments, the computing device 300 includes a processor subsystem that includes one or more processors 302. Processor 302 may be or may include, one or more programmable general-purpose or special-purpose microprocessors, digital signal processors (DSPs), programmable controllers, application specific integrated circuits (ASICs), programmable logic devices (PLDs), or the like, or a combination of such hardware based devices.

The computing device 300 can further include a memory 304, a network adapter 310, a cluster access adapter 312 and a storage adapter 314, all interconnected by an interconnect 308. Interconnect 308 may include, for example, a system bus, a Peripheral Component Interconnect (PCI) bus, a HyperTransport or industry standard architecture (ISA) bus, a small computer system interface (SCSI) bus, a universal serial bus (USB), or an Institute of Electrical and Electronics Engineers (IEEE) standard 1394 bus (sometimes referred to as “Firewire”) or any other data communication system.

The cluster access adapter 312 includes multiple ports adapted to couple the computing device 300 to other host devices. In the illustrated embodiment, Ethernet can be used as the clustering protocol and interconnect media, although other types of protocols and interconnects may be utilized within the cluster architecture described herein. In various alternative embodiments in which the N-modules and D-modules are implemented on separate storage systems or computers, the cluster access adapter 312 can be utilized by the N-module and/or D-module for communicating with other N-modules and/or D-modules of the cluster.

The computing device 300 can be embodied as a single- or multi-processor storage system executing a storage operating system 306 that can implement a high-level module, e.g., a storage manager, to logically organize the information as a hierarchical structure of named directories, files and special types of files called virtual disks (hereinafter generally “blocks”) at the storage devices. For example, one processor 302 can execute the functions of an N-module on a node while another processor 302 executes the functions of a D-module on the node.

The memory 304 can comprise storage locations that are addressable by the processor(s) 302 and adapters 310, 312, and 314 for storing processor-executable instructions and/or data structures. The processor 302 and adapters 310, 312, and 314 may, in turn, comprise processing elements and/or logic circuitry configured to execute the software code and manipulate the data structures. The storage operating system 306, portions of which are typically resident in memory and executed by the processors(s) 302, functionally organizes the computing device 300 by (among other things) configuring the processor(s) 302 to invoke storage operations in support of the storage service provided by a node. It will be apparent to those skilled in the art that other processing and memory implementations, including various computer readable storage media, may be used for storing and executing program instructions pertaining to the technology.

The network adapter 310 can include multiple ports to couple the computing device 300 to one or more clients over point-to-point links, wide area networks, virtual private networks implemented over a public network (e.g. the Internet) or a shared local area network. The network adapter 310 thus can include the mechanical, electrical and signaling circuitry needed to connect the computing device 300 to the network. Illustratively, the network can be embodied as an Ethernet network or a Fibre Channel (FC) network. A client can communicate with a node over the network by exchanging discrete frames or packets of data according to pre-defined protocols, e.g., TCP/IP.

The storage adapter 314 can cooperate with the storage operating system 306 to access information requested by a client. The information may be stored on any type of attached array of writable storage media, e.g., magnetic disk or tape, optical disk (e.g., CD-ROM or DVD), flash memory, solid-state disk (SSD), electronic random access memory (RAM), micro-electro mechanical and/or any other similar media adapted to store information, including data and parity information. For example, as illustrated in FIG. 2, the information can be stored on mass storage devices in storage devices 212A-212L. The storage adapter 314 can include multiple ports having input/output (I/O) interface circuitry that couples to the disks over an I/O interconnect arrangement, e.g., a conventional high-performance, Fibre Channel (FC) link topology. In various embodiments, the cluster access adapter 312 and the storage adapter 314 can be implemented as one adaptor configured to connect to a switching fabric, e.g., a storage network switch, in order to communicate with other host devices and the mass storage devices.

Storage of information on mass storage devices in storage devices 212A-212L can be implemented as one or more storage volumes that include a collection of physical storage disks cooperating to define an overall logical arrangement of volume block number (VBN) space on the volume(s). The mass storage devices in storage devices 212A-212L can be organized as a RAID group. One or more RAID groups can form an aggregate. An aggregate can contain one or more volumes and/or file systems.

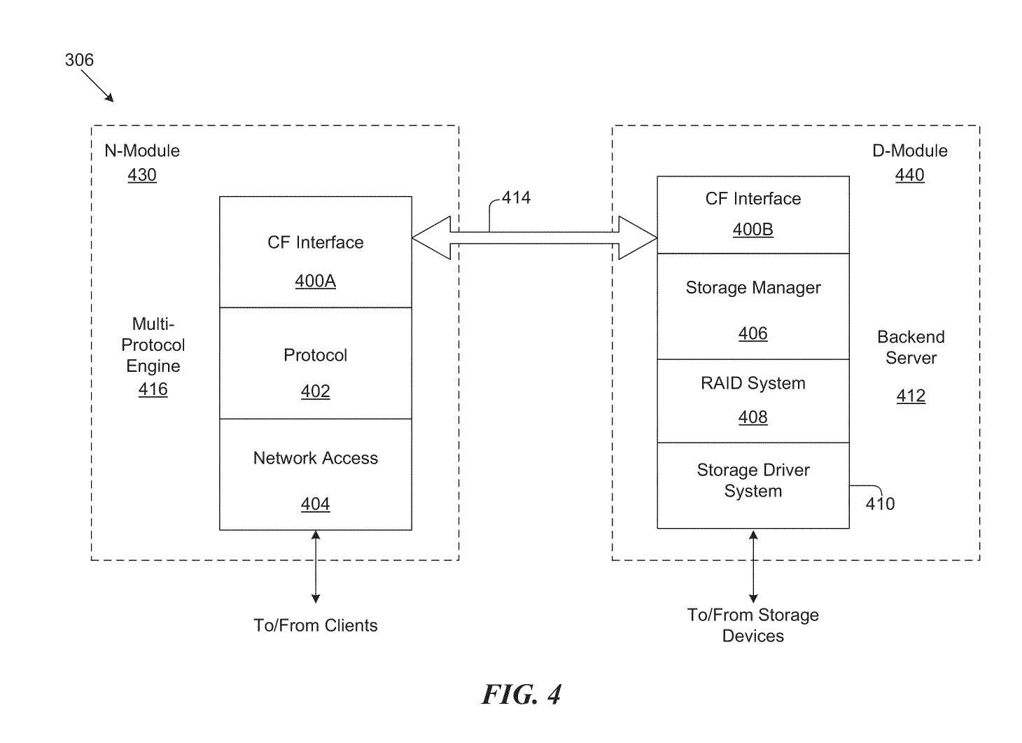

The storage operating system 306 facilitates clients' access to data stored on the storage devices. In various embodiments, the storage operating system 306 implements a write-anywhere file system that cooperates with one or more virtualization modules to “virtualize” the storage space provided by storage devices. For example, a storage manager (e.g. as illustrated in FIG. 4 and described in further detail below) can logically organize the information as a hierarchical structure of named directories and files on the storage devices. An “on-disk” file may be implemented as set of disk blocks configured to store information, e.g., data, whereas the directory may be implemented as a specially formatted file in which names and links to other files and directories are stored. The virtualization module(s) allow the storage manager to further logically organize information as a hierarchical structure of blocks on the disks that are exported as named logical unit numbers (LUNs). In various embodiments, the storage manager of the storage operating system 306 can implement a file system using a “write anywhere file layout” technology, e.g., NetApp's WAFL® technology.

FIG. 4 is a block diagram illustrating an example of a storage operating system 306 of a storage host device, in which the technology can be implemented in various embodiments. The storage operating system 306 may be used to maintain various data structures for providing access to the stored data.

In the illustrated embodiment, the storage operating system 306 includes multiple functional layers organized to form an integrated network protocol stack or, more generally, a multi-protocol engine 416 that provides data paths for clients to access information stored on the mass storage devices using block and file access protocols. The multi-protocol engine 416 in combination with underlying processing hardware also forms an N-module 430. The multi-protocol engine 416 includes a network access layer 404 that includes one or more network drivers that implement one or more lower-level protocols to enable the processing system to communicate over the network 206, e.g., Ethernet, Internet Protocol (IP), Transport Control Protocol/Internet Protocol (TCP/IP), Fibre Channel Protocol (FCP) and/or User Datagram Protocol/Internet Protocol (UDP/IP). The multi-protocol engine 416 can also include a protocol layer 402 that implements various higher-level network protocols, e.g., Network File System (NFS), Common Internet File System (CIFS), Hypertext Transfer Protocol (HTTP), Internet small computer system interface (iSCSI), etc. Further, the multi-protocol engine 416 can include a cluster fabric (CF) interface module 400A that implements intra-cluster communication with other D-modules and/or N-modules.

In addition, the storage operating system 306 includes a set of layers organized to form a backend server 412 that provides data paths for accessing information stored on the storage devices in storage devices. The backend server 412 in combination with underlying processing hardware also forms a D-module 440. To that end, the backend server 412 includes a storage manager module 406 that can manage a number of storage volumes, a RAID system module 408 and a storage driver system module 410.

The storage manager 406 can manage a file system (or multiple file systems) and serve client-initiated read and write requests. The RAID system 408 manages the storage and retrieval of information to and from the volumes/disks in accordance with a RAID redundancy protocol, e.g., RAID-4, RAID-5, or RAID-DP, while the storage driver system 410 implements a disk access protocol e.g., SCSI protocol, Serial Attached SCSI (SAS) protocol or FCP.

The backend server 412 also includes a CF interface module 400B to implement intra-cluster communication 414 with other N-modules and/or D-modules. In various embodiments, the CF interface modules 400A and 400B can cooperate to provide a single domain across the storage system. Thus, a network port of an N-module that receives a client request can access any data within the single domain located on any mass storage device in any storage device.

The CF interface modules 400A and 400B implement the CF protocol to communicate file system commands among the modules of cluster over the cluster switching fabric (e.g. 210 in FIG. 2). Such communication can be effected by a D-module exposing a CF application programming interface (API) to which an N-module (or another D-module) issues calls. To that end, a CF interface module can be organized as a CF encoder/decoder. The CF encoder of, e.g., CF interface 400A on N-module 430 can encapsulate a CF message as (i) a local procedure call (LPC) when communicating a file system command to a D-module 440 residing on the same node or (ii) a remote procedure call (RPC) when communicating the command to a D-module residing on a remote node of the cluster. The CF decoder of CF interface 400B on D-module 440 can de-encapsulate the CF message and process the file system command.

In operation of a storage host device, a request from a client can be forwarded as a packet over a network to the node, where it is received at a network adapter (e.g. 310 in FIG. 3). A network driver of layer 404 processes the packet and, if appropriate, passes it on to a network protocol and file access layer for additional processing prior to forwarding to the storage manager 406. The storage manager 406 can then generate operations to load (e.g. retrieve) the requested data from storage device if it is not resident in the memory of the node. If the information is not in the memory, the storage manager 406 can index into a metadata file to access an appropriate entry and retrieve a logical virtual block number (VBN). The storage manager 406 can then pass a message structure including the logical VBN to the RAID system 408; the logical VBN can then be mapped to a disk identifier and disk block number (DBN) and sent to an appropriate driver (e.g. SCSI) of the storage driver system 410. The storage driver can access the DBN from the specified storage device 212 and loads the requested data block(s) in memory for processing by the node. Upon completion of the request, the node (and operating system) can return a reply to the client over the network.

The data request/response “path” through the storage operating system 306 as described above can be implemented in general-purpose programmable hardware executing the storage operating system 306 as software or firmware. Alternatively, it can be implemented at least partially in specially designed hardware. That is, in an alternate embodiment of the technology, some or all of the storage operating system 306 is implemented as logic circuitry embodied within a field programmable gate array (FPGA) or an application specific integrated circuit (ASIC), for example.

The N-module 430 and D-module 440 can be implemented as processing hardware configured by separately-scheduled processes of storage operating system 306. However, in an alternate embodiment, the modules may be implemented as processing hardware configured by code within a single operating system process. Communication between an N-module 430 and a D-module 440 can thus be effected through the use of a message passing between the modules although, in the case of remote communication between an N-module and D-module of different nodes, such message passing occurs over a cluster switching fabric. The message-passing mechanism provided by the storage operating system to transfer information between modules (processes) can be the Inter Process Communication (IPC) mechanism. The protocol used with the IPC mechanism is illustratively a generic file and/or block-based “agnostic” CF protocol that comprises a collection of methods/functions constituting a CF API.

### Cache Process and Data Structure

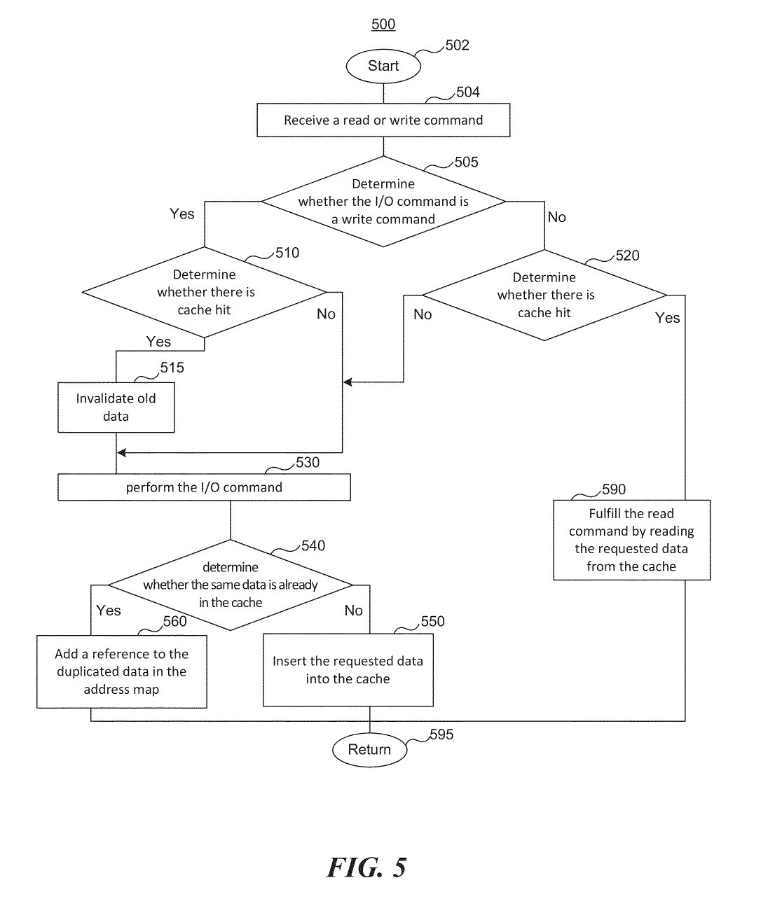

In various embodiments, the cache can generate or update an address map based on the received duplication list, e.g., at a server computing device, when performing I/O commands. FIG. 5 is a flow diagram illustrating a process 500 for handling an I/O command, in connection with a cache, in various embodiments. The cache can process the I/O command based on the command type of the I/O command. The I/O command type can be, e.g., a read or a write command. The process 500 starts at block 504, where the storage device receives a read or write command. At decision block 505, the storage device determines whether the I/O command is a write command. If the I/O command is a write command, the process 500 continues to decision block 510. If the I/O command is a not write command (e.g., a read command), the process 500 continues to decision block 520.

At decision block 510 after determining the command is a write command, the cache determines whether there is cache hit, which means the requested data is contained in the cache. If there is a cache hit, the old data in the cache will be invalidated at block 515, because the old data cannot be used for future read commands after the write command changes the content of the data (e.g. data block) associated with the write command. If there is no cache hit, the process continues to block 530 to perform the I/O command (e.g., write the data).

At decision block 520 after determining the command is a read command, the cache determines whether there is cache hit, which means the requested data is contained in the cache. If there is a cache hit, the cache fulfills the read command by reading the requested data from the cache itself at block 590. If there is no cache hit, the process 500 continues to block 530 to perform the I/O command (e.g., read the data from storage).

For both read miss and write, at block 530, the process 500 performs the I/O command by, e.g., sending a data request to a storage server. Once the requested data is retrieved from, e.g., the storage server, the process 500 determines whether the same data is already in the cache at decision block 540. If the data is not in the cache, the process 500 inserts the requested data into the cache at block 550. If the data has already been in the cache, at block 560, the process 500 adds a reference to the duplicated data in the address map.

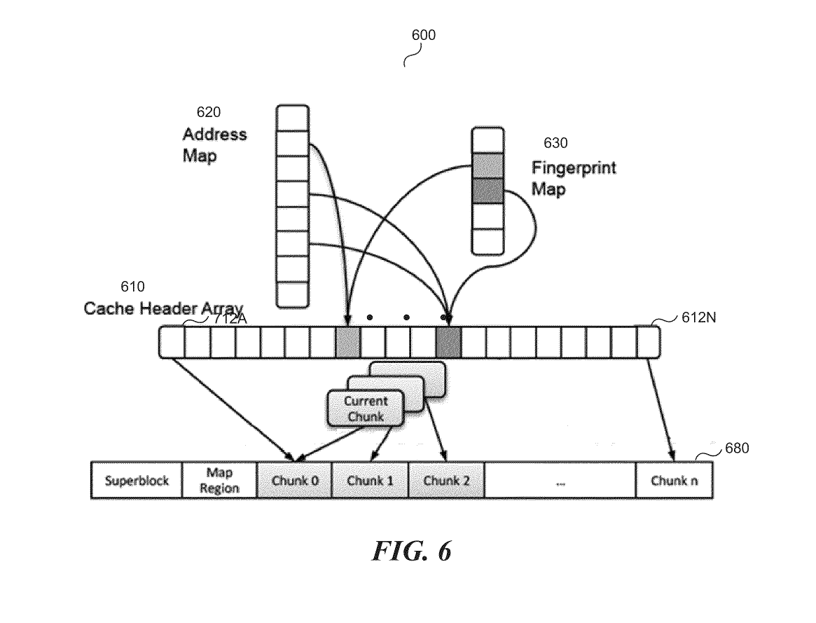

The address map data structure records the cache location of a storage address. Multiple storage addresses can reference the same cache location when deduplication is enabled (shown in FIG. 6, where two address map entries point to a cache header). When receiving a server duplication list, the cache would its address map so that the duplication storage server addresses also reference the cache location of the storage server address they are a duplicate of.

Those skilled in the art will appreciate that the logic illustrated in FIG. 5 and described above, and in each of the flow diagrams discussed below, may be altered in a various ways. For example, the order of the logic may be rearranged, substeps may be performed in parallel, illustrated logic may be omitted, other logic may be included, etc.

In various embodiments, the server duplication list can be implemented in the cache data structures. FIG. 6 is block diagram illustrating an example of a cache data structure 600 for cache 680 comprising a cache header array 610, an address map 620 and a fingerprint map 630, in various embodiments. These three components 610, 620 and 630 of the cache data structure 600 can together be used to determine cache hits and detect duplication. For example, the cache data structured can be maintained in a memory by a cache manager. The cache data structure 600 and the cache 680 illustrated in FIG. 6 can use blocks as the unit of data. A person having ordinary skill in the art readily understands that the technology illustrated herein can be applied to situations whether other types of data units are used, e.g. chunk or Logical Unit Number (“LUN”).

The cache header array 610 can include multiple header fields 612A-612N. Each of the header fields 612A-612N can include, e.g., a reference to block addresses that have the same (e.g., duplicate) content, the number of the block addresses, and optionally a fingerprint of the block data (e.g. a SHA256 fingerprint or Adler-32 fingerprint). A storage server can communicate duplication information to the storage client. Accordingly, block addresses associated with the duplicate content can be saved in the cache header array 610, regardless of whether the duplicate content has been stored in the cache 680 or not. In various embodiments, the cache header array 610 may only store block addresses associated with the duplicate data that are stored in the cache 680.

The cache 680 can be a deduplicated cache. In deduplicated cache, all blocks on the cache may be unique. All or at least some of the block addresses that point to each unique block can be in an efficient way to save memory consumption. Data fingerprints can be used to detect duplication. The fingerprint map 630 keeps track of unique fingerprints of data stored in the cache 680. When data is read from or written to a storage server, the data is inserted into the cache 680. The fingerprint of the data is calculated and compared to the entries of the fingerprint map 630. If the fingerprint of the data exists in the fingerprint map 630, a copy of the same data is already in the cache 680.

Fingerprints can be further used to validate data consistency. When there is a read hit and data is retrieved from the cache 680, fingerprints saved in the header are used to validate the data consistency by comparing it to a fingerprint generated from the retrieved data.

As illustrated in FIG. 5-6, the storage server efficiently communicates duplication information to a storage client. By sharing the duplication information, the storage server can reduce the number of read requests storage clients transmit to the storage server. The storage server identifies and tracks data duplication, e.g., by using known deduplication technology. Fixed-length (e.g. block) and variable-length deduplication algorithms can be used to detect the data duplication on the storage server. For example, NetApp's A-SIS product uses fixed-length deduplication. EMC's Data Domain product uses variable-length deduplication. As the next section illustrates, the storage server can prune the duplication information to be sent to the storage client in order to increase the efficiency of the storage server and client.

### Pruning the Server Duplication List

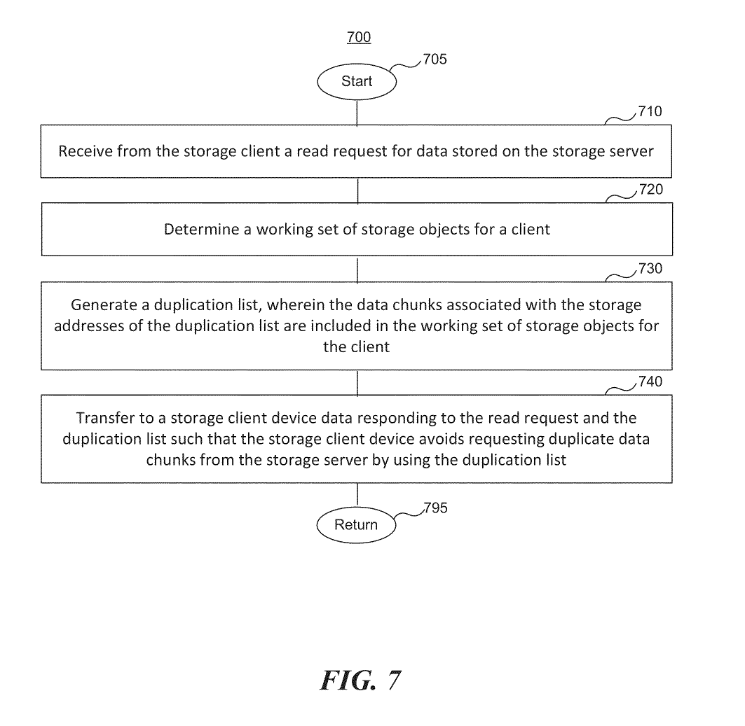

FIG. 7 is a flow diagram illustrating a process 700 for pruning a storage server duplication list based on a client's working set. The process 700 starts at block 710, where a storage server receives from the storage client (also referred to as storage client device) a read request for data stored on the storage server. Once the storage server receives the read request, the server can respond to the request by sending the data requested to the storage client. The server can further piggyback a duplication list along with the data in response to the request. A duplication list includes storage addresses of data chunks that are duplicate of another data chunk associated with a storage address of the duplication list. Alternatively, the server can send the duplication list to the storage client at other times. For example, the server can respond to an explicit request for a duplication list from the storage client by sending the duplication list. The server can also periodically transfer the duplication list and its updates to the storage client.

The process 700 continues to block 720, where the storage server determines a working set of storage objects for a client. The working set includes one or more storage objects stored at the storage server. For example, the storage objects of the working set can be objects that are referenced (e.g., for reading or writing) by the client. The working set can be determined by monitoring data access pattern of the client. For example, the working set can be determined by tracking input and output operations on the storage server for the client.

After determining the working set, at block 730, the storage server generates a duplication list, wherein the data chunks associated with the storage addresses of the duplication list are included in the working set of storage objects for the client. In other words, duplicate data chunks that are irrelevant to the working set of the client are excluded (also referred to as pruned) from the duplication list.

At block 740, responding to the read request, the storage server transfers to the storage client device data responding to the read request and the duplication list such that the storage client device therefore can avoid requesting duplicate data chunks from the storage server by checking the duplication list. The duplication list identifies data chunks that have the same data content. If the same data content is stored in a cache of the storage client device, the storage client device can locally satisfied data read operation for these data chunks using the data content stored in its cache. In other words, the storage client device satisfies a read operation for one of the multiple data chunks by retrieving the same data content from the cache of the storage client device, without sending a data request to the storage server.

Although the sample process 700 uses data chunks as the data granularity for the duplication list, the data granularity can be data block, Logic Unit Numbers (LUNs) or other types of data units.

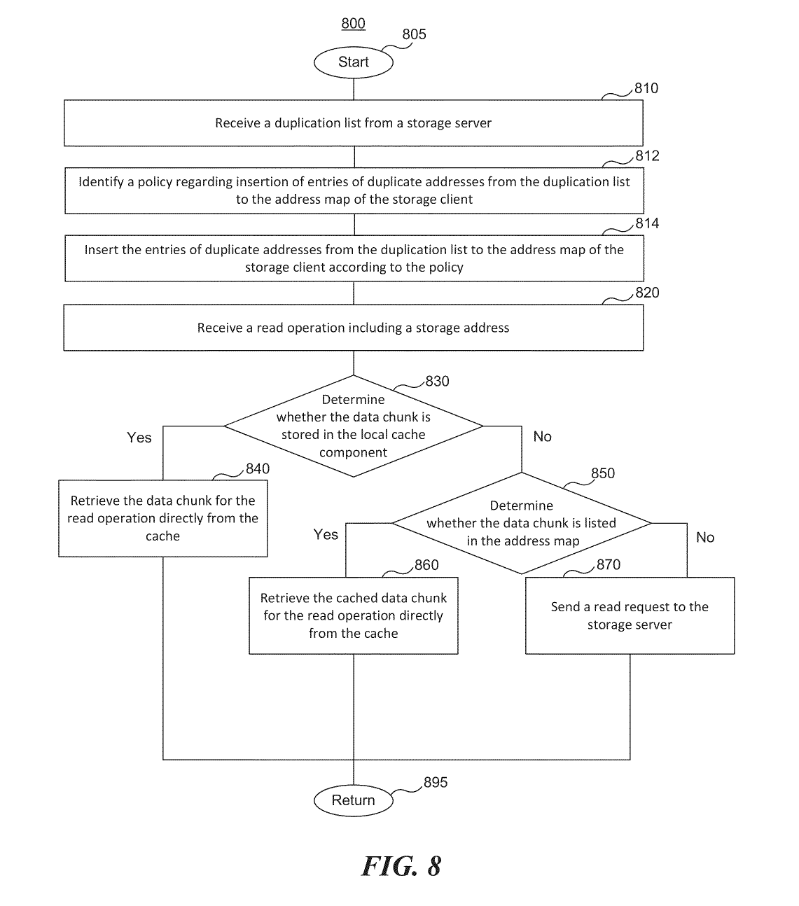

Once the storage client receives the duplication list, the storage client improves the local cache hit rate based on the duplication list. FIG. 8 is a flow diagram illustrating a process 800 for using a server duplication list to improve a cache hit rate in a storage client consistent with various embodiments. The process 800 starts at block 810, where the storage client receives a duplication list from a storage server. The duplication list includes storage addresses of data chunks that duplicate a different data chunk associated with a storage address of the duplication list.

Optionally at block 812, the storage client identifies a policy regarding insertion of entries of duplicate addresses from the duplication list to the address map of the storage client. For example, the default policy can be that all addresses from the duplication list should be inserted to the address map. Another policy can be, e.g., that the storage client only records addresses from the duplication list to the address map if the address map is occupying less than an amount of memory determined by a threshold value. At block 814, the storage client insert the entries of duplicate addresses from the duplication list to the address map of the storage client according to the policy.

At block 820, the storage client receives a read operation including a storage address. The storage address identifies a data chunk on the storage server that the read operation is to retrieve. At decision block 830, the storage client determines whether the data chunk is stored in the local cache component, e.g., by comparing the storage address to data structures for cached data chunks. This can be performed, e.g., by an operation module of the storage client. The cache component can include a solid-state drive (e.g. a flash-based solid-state drive) or other hardware media such as storage class memory. If the data chunk is cached, at decision block 840, the storage client retrieves the data chunk for the read operation directly from the cache instead of sending a request to the storage server.

If the data chunk is not cached, at decision block 850, the storage client further determines whether there is at least one storage address from the address map that is associated with a data chunk duplicate to the data chunk associated with the storage address of the read operation. If so, these two data chunks are duplicates, and the storage client retrieves the cached data chunk for the read operation directly from the cache at block 860.

If there is no duplicate data chunk in the cache identified based on the duplication list, at block 870, the storage client sends a read request to the storage server to retrieve data for the read operation from the storage server.

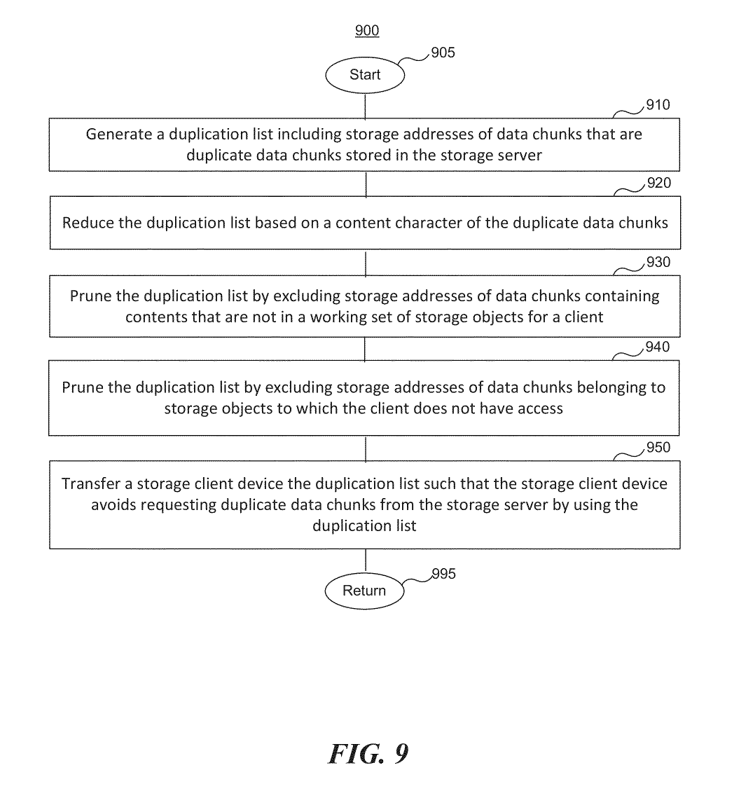

The duplication list can be pruned by other criteria besides a working set of a client. FIG. 9 is a flow diagram illustrating a process 900 for pruning a server duplication list based on data content's characteristics consistent with various embodiments. The process 900 starts at block 910, where the storage server generates a duplication list including storage addresses of data chunks that are duplicate data chunks stored in the storage server.

At block 920, the storage server reduces (“prunes”) the duplication list based on a content character of the duplicate data chunks. The content character can be a duplication degree. A duplication degree of a data chunk is, or can be calculated from, a number of duplicate data chunks that have the same content. The duplication list can be reduced by removing from the duplication list storage addresses of data chunks having duplication degrees less than a specified duplication degree threshold.

Alternatively, the content character can be a data access frequency. A data access frequency is, or can be calculated from, a number of times that common content of duplicate data chunks has been accessed. The duplication list can be reduced by removing from the duplication list storage addresses of data chunks having data access frequency less than a specified threshold access frequency.

For example, the storage server can use estimate values or average values of the duplication degree and access frequency (e.g. degree and frequency values accurate as of the last hour). By using the estimate values or average values based on historical data, the hardware burden for computing the values is lighter than the burden for computing these on the fly for every request. Pre-computing the duplication list is performed in a way that the list is guaranteed to only contain addresses that are still duplicates of the data chunk and subsequent write operations do break the duplication relationship.

Optionally at block 930, the storage server can further prune the duplication list by excluding storage addresses of data chunks containing content that is not in a working set of storage objects for a client, e.g., in a way similar to the process 700. Optionally at block 940, the storage server can further prune the duplication list by excluding storage addresses of data chunks belonging to storage objects to which the client does not have access, in a way similar to the process 1000 disclosed in following paragraphs.

At block 950, the storage server transfers to a storage client device the reduced or pruned duplication list such that the storage client device, by using the duplication list avoids requesting duplicate data chunks from the storage server.

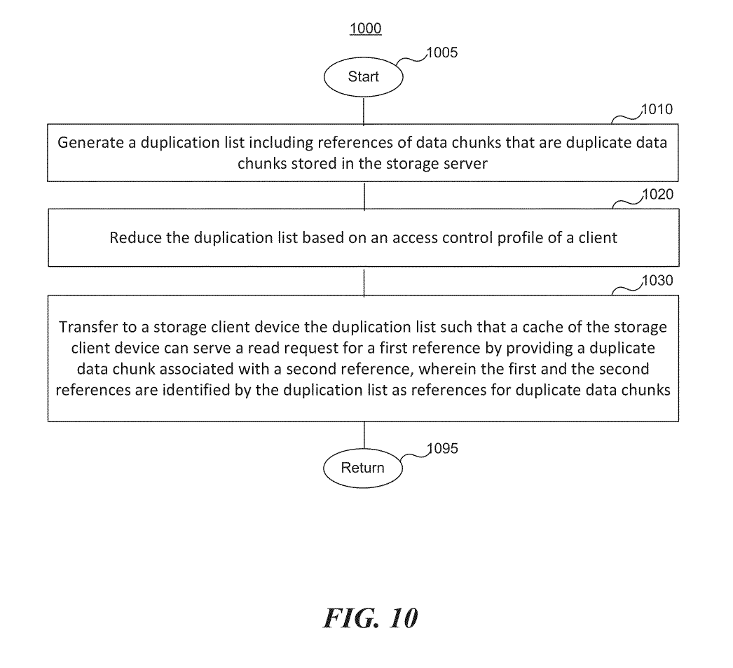

FIG. 10 is a flow diagram illustrating a process 1000 for pruning a server duplication list based on access control lists consistent with various embodiments. The process 1000 starts at block 1010, where the storage server generates a duplication list including references of data chunks that are duplicate data chunks stored at the storage server. The data chunks can be data blocks, and the references of the data chunks can be block addresses of the data blocks. The data blocks can include variable sized blocks.

At block 1020, the storage server reduces the duplication list based on an access control profile of a client. The access control profile of the client can include a list of access rights to storage objects stored in the storage server. For example, the duplication list can be reduced by excluding references to data chunks belonging to storage objects to which the client does not have access. The storage objects can include data files and/or directories. The client can be represented by at least one storage account from the storage client device. The access control profile of the client may include multiple access rights of the storage account to access storage objects stored at the storage server.

At block 1030, the storage server transfers to a storage client device the duplication list such that a cache of the storage client device can serve a read request for a first reference by providing a duplicate data chunk associated with a second reference, wherein the first and the second references are identified by the duplication list as references for duplicate data chunks.

Those skilled in the art will appreciate that the logic illustrated in FIGS. 7-10 and described above, and in each of the flow diagrams discussed below, may be altered in a variety of ways. For example, the order of the logic may be rearranged, substeps may be performed in parallel, illustrated logic may be omitted, other logic may be included, etc. The substeps of the FIGS. 7-10 can be combined into a single process. In other words, the duplication list can be pruned by one or more of the criteria including the working set, content characteristics, access control lists, or other criterions that are readily appreciated by a person having ordinary skill in the art.

The network protocols used to communicate duplication lists between a storage client and a storage server can be based on standardized protocols or specialized protocols. The technology described herein is independent of specific protocol mechanisms. Industry standard protocols or proprietary protocols can be used to implement the technology.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. Accordingly, the invention is not limited except as by the appended claims.

What is claimed is:

1. A method, comprising:
determining, at a storage server, a working set of storage objects for a client, wherein the working set includes one or more storage objects stored in the storage server and accessed by the client;
generating, at the storage server, a duplication list including storage addresses of data chunks that contain duplicate data, wherein the data chunks associated with the storage addresses of the duplication list are included in the working set of storage objects for the client; and
transferring, from the storage server to a storage client device, the duplication list such that the storage client device avoids requesting duplicate data chunks from the storage server by using the duplication list.

2. The method of claim 1, wherein the duplication list identifies multiple data chunks that have the same data content, and the same data content is stored in a cache of the storage client device.

3. The method of claim 2, wherein the storage client device satisfies a read operation for one of the multiple data chunks by retrieving the same data content from the cache of the storage client device, without sending a data request to the storage server.

4. The method of claim 1, wherein the working set includes one or more storage objects stored in the storage server that are opened by the storage client device.

5. The method of claim 1, wherein the working set is determined by monitoring a data access pattern of the storage client device.

6. The method of claim 1, wherein the working set is determined by tracking a history of input and output operations on the storage server for the storage client device over a period of time.

7. The method of claim 1, further comprising:
receiving, at the storage server from the storage client device, a read request for data stored at the storage server.

8. The method of claim 7, wherein the transferring comprises:
transferring, from the storage server to the storage client device, data responding to the read request and the duplication list such that the storage client device avoids requesting duplicate data chunks from the storage server by using the duplication list.

9. The method of claim 8, wherein the storage client device checks the duplication list before sending the read request to the storage server.

10. The method of claim 1, wherein the working set of storage objects are stored within a virtual disk image.

11. A computing device, comprising:
a networking interface configured to receive a duplication list from a storage server, wherein the duplication list includes storage addresses of data chunks that contain duplicate data;
a cache component configured to cache data for read operations;
a processor configured to generate a read operation including a storage address; and
an operation module configured to identify one or more storage addresses from the duplication list that are associated with data chunks that are duplicates of data chunks associated with the storage address of the read operation;
the operation module further configured to retrieve data for the read operation from the cache if at least one of the identified storage addresses is associated with data stored in the cache.

12. The computing device of claim 11, wherein the operation module is further configured to retrieve data for the read operation from the cache if the storage address of the read operation is associated with data stored in the cache.

13. The computing device of claim 11, wherein the operation module is further configured to retrieve the data for the read operation from the storage server if no storage address from the duplication list is identified as being associated with any data chunk that is a duplicate of the data chunk associated with the storage address of the read operation.

14. The computing device of claim 11, wherein the operation module is further configured to the retrieve data for the read operation from the storage server if none of the one or more identified storage addresses is associated with data stored in the cache.

15. The computing device of claim 11, wherein the cache component includes a solid-state drive.

16. The computing device of claim 11, wherein the cache component is further configured to serve read operations for cached data chunks stored in the cache as well as for data chunks are duplicate data chunks to the cached data chunks according to the duplication list.

17. A processor-executable storage medium storing instructions, comprising:
instructions for generating, at a storage server, a duplication list including storage addresses of data chunks that are duplicate data chunks stored in the storage server;
instructions for reducing, at the storage server, the duplication list based on a content character of the duplicate data chunks; and
instructions for transferring, from the storage server to a storage client device, the duplication list such that the storage client device avoids requesting duplicate data chunks from the storage server by using the duplication list.

18. The processor-executable storage medium of claim 17, wherein the content character is a duplication degree; and
wherein the reducing comprises:
reducing, at the storage server, the duplication list by removing storage addresses of data chunks having duplication degrees less than a predetermined degree value from the duplication list;
wherein a duplication degree is related to a number of duplicate data chunks that have a common content.

19. The processor-executable storage medium of claim 17, wherein the content character is a data access frequency; and
wherein the reducing comprises:
reducing, at the storage server, the duplication list by removing storage addresses of data chunks having data access frequency less than a predetermined frequency value from the duplication list;
wherein a data access frequency is related to a number of times that a common content of duplicate data chunks has been accessed.

20. The processor-executable storage medium of claim 17, further comprising instructions for:
pruning, at the storage server, the duplication list by excluding storage addresses of data chunks containing contents that are not in a working set of storage objects for a client.

21. The processor-executable storage medium of claim 17, further comprising instructions for:
pruning, at the storage server, the duplication list by excluding storage addresses of data chunks belonging to storage objects to which the client does not have access.

22. A method, comprising:
generating, at a storage server, a duplication list including references of data chunks that are duplicate data chunks stored in the storage server;
reducing, at the storage server, the duplication list based on an access control profile of a client; and
transferring, from the storage server to a storage client device, the duplication list such that a cache of the storage client device can serve a read request for a first reference by providing a duplicate data chunk associated with a second reference;
wherein the first and the second references are identified by the duplication list as references for duplicate data chunks.

23. The method of claim 22, wherein the reducing comprises:
reducing, at the storage server, the duplication list by excluding references of data chunks belonging to storage objects to which the client does not have access.

24. The method of claim 22, wherein the access control profile of the client includes a list of access rights to storage objects stored in the storage server.

25. The method of claim 24, wherein at least one of the access rights is determined by a network protocol.

26. The method of claim 22, wherein the storage objects include data files or directories.

27. The method of claim 22, wherein the client is represented by at least one storage account from the storage client device, and the access control profile of the client includes multiple access rights of the storage account to access storage objects stored in the storage server.

28. The method of claim 22, wherein the data chunks are data blocks, and the references of the data chunks are block addresses of the data blocks.

29. The method of claim 27, wherein the data blocks include variable sized blocks.
